(19) United States
(12) Patent Application Publication
(10) Pub. No.: US 2026/0126466 A1
(43) Pub. Date: May 7, 2026

(54) BUBBLE SHEAR STRESS SENSOR AND RELATED METHODS

(71) Applicant: Regents of the University of Michigan, Ann Arbor, MI (US)

(72) Inventors: David Russell Dowling, Ann Arbor, MI (US); Steven Louis Ceccio, Dexter, MI (US); Joshua Harvey Snyder, Ann Arbor, MI (US)

(21) Appl. No.: 18/949,044

(22) Filed: Nov. 15, 2024

Related U.S. Application Data
(60) Provisional application No. 63/599,879, filed on Nov. 16, 2023.

(51) Int. Cl. G01P 5/00

(52) U.S. Cl. CPC G01P 5/001

(57) ABSTRACT

The disclosure relates to a sensor for detection and measurement of one or more of wall-shear-stress, near-wall flow-direction, and flow speed in wall-bounded flows over curved or flat surfaces. The sensor can include an electrode system with a central electrode probe and a far electrode array. The sensor uses small air bubbles produced at the central electrode probe in a liquid cross-flow across the sensor's surface, an array of circumferentially distributed downstream far electrodes, and electrical impedance changes induced by the small bubbles to determine bubble shedding rates and convection directions. The bubble shedding rate is proportional to the wall shear stress, and downstream impedance signatures indicate surface flow direction. The sensor can increase the accuracy and robustness of surface flow measurements while reducing their cost and difficulty.

### CROSS REFERENCE TO RELATED APPLICATION

Priority is claimed to U.S. Provisional Application No. 63/599,879 filed on Nov. 16, 2023, which is incorporated herein by reference in its entirety.

### STATEMENT OF GOVERNMENT INTEREST

This invention was made with government support under N00014-19-C-1029 awarded by the Office of Naval Research. The government has certain rights in the invention.

### BACKGROUND OF THE DISCLOSURE

### Field of the Disclosure

The disclosure relates to a sensor for detection and measurement of one or more of wall-shear-stress, near-wall flow-direction, and flow speed in wall-bounded flows over curved or flat surfaces. The sensor can include an electrode system with a central electrode probe and a far electrode array. Electrical impedance measurements resulting from bubbles injected into a liquid flow environment adjacent to the sensor can be used to determine the flow properties in the liquid flow environment.

### Background

Methods currently used to measure the shear stress exerted onto a body's surface by water flow are often costly, complex, unreliable, or cause nontrivial downstream flow perturbation. Two sensing methods for shear stress are discussed below: 1) particle imaging velocimetry, which provides highly resolved flow characterization but is costly and complex, and 2) floating plate instrumentation, which is robust but limited in resolution.

Particle Imaging Velocimetry (PIV) is the most widely used method of spatially-resolved flow measurement and characterization in modern hydrodynamic research. Particle seeding is incorporated into the water flow, either locally to the imaging area through injection, or globally to the entire volume through flooding. A pulsed sheet of laser light is then emitted through the area of interest, illuminating a plane of particles which is captured synchronously with a high-speed camera. Software is used to determine flow speed and direction based on the displacement of particles between frames. PIV produces highly resolved flow fields, but is very complex and sensitive: Costly optics and lasers must be precisely aligned and maintained, and the equipment must be either set up externally to the flow loop, or included internally in the model and interfaced optically with the water, which adds additional complexity.

The floating plate balance is another method used to measure surface shear stress. A plate is flush mounted to the surface of the model and potted into place with a compliant material to allow movement. The plate is coupled to a sensitive load cell and the force exerted on the plate by the flowing water is measured, allowing for the direct calculation of shear stress. Although robust, the high inertia of the plate does not allow for measurement of rapidly fluctuating flow, as is often the case within turbulent boundary layers.

These current methods for shear stress measurement each pose limitations in terms of either durability or responsiveness to fluctuations in flow.

### SUMMARY

The disclosure relates to a sensor for detection and measurement of one or more of wall-shear-stress, near-wall flow-direction, and flow speed in wall-bounded liquid (e.g., water or otherwise) flows over curved or flat surfaces. This sensor/transducer or corresponding instrument incorporating the sensor allows for the measurement of water or other liquid flow speed/velocity, direction, and shear stress exerted by the water on a surface (i.e., wall shear stress). The sensor provides a simple, rugged option for wall shear stress, water direction and speed measurement, and it can be used for quick and reliable data collection in environments where other techniques fail or are unreliable. The sensor can be installed onto a liquid-submerged model, object, wall, or other surface to provide wall shear stress, flow speed, and flow direction data for liquid cross flow over the surface. The sensor generally includes sensing electrodes (or impedance probes), an (air) bubble generator (e.g., syringe pump or other air/gas source), and sensing electronics (e.g., lock-in amplifier, half-Wheatstone bridge). The bubble shedding rate or frequency (e.g., rate at which bubbles are generated at a sensor central orifice) and/or time of flight of generated bubbles in a liquid cross-flow are measured by their impedance signal using the electrodes. The wall shear stress is directly proportional to the bubble shedding rate/frequency, so the wall shear stress can be determined from the measured bubble shedding rate (e.g., via a suitable calibration curve for the sensor). A ring of outer electrodes detects the direction of the produced bubbles.

In an aspect, the disclosure relates to a sensor apparatus for detection of one or more liquid flow properties, the sensor comprising: a sensor housing defining a sensing (or bottom) surface; a central electrode probe positioned within the sensor housing and at the sensing surface, the central electrode probe comprising: an inner electrode conduit (or tube) exposed at the sensing surface and defining a gas delivery passage through the sensor housing to the sensing surface, and an outer electrode conduit (or tube) exposed at the sensing surface and being positioned around, spaced apart from, and electrically isolated from the inner electrode conduit; and optionally a far electrode array within the sensor housing and at the sensing surface, the far electrode array comprising: a plurality of far electrodes exposed at the sensing surface, each far electrode being spaced apart from and electrically isolated from other far electrodes and the central electrode probe, and a ground electrode exposed at the sensing surface being spaced apart from and electrically isolated from the plurality of far electrodes and the central electrode probe. In some embodiments, the sensor can omit the far electrode array, for example having only a central electrode to detect bubble shedding rate only at the sensor center for correlation with wall shear stress and/or flow speed, but without flow direction information from the far electrodes. In other embodiments, the sensor can include the far electrode array, thus being able to detect wall shear stress (e.g., using the central electrodes alone), flow speed, and/or flow direction.

Various refinements and embodiments of the disclosed sensor apparatus are possible.

In a refinement, the inner electrode conduit and the outer electrode conduit are coaxially aligned.

In a refinement, the inner electrode conduit comprises a cylindrical inner electrode tube; the outer electrode conduit comprises a cylindrical outer electrode tube; the plurality of far electrodes comprises a plurality of far electrode wires; and/or the ground electrode comprises ground electrode ring encircling the plurality of far electrode wires. In a refinement, the inner electrode tube has a diameter in a range of 0.01 mm to 0.2 mm (or 0.03 mm to 0.1 mm; ranges can represent ID or OD); the outer electrode tube has a diameter in a range of 0.3 mm to 3 mm (or 0.6 mm to 1.5 mm; ranges can represent ID or OD); each far electrode wire has a diameter in a range of 0.02 mm to 0.4 mm (or 0.05 mm to 0.5 mm); and/or the ground electrode ring has an inner diameter in a range of 2 mm to 20 mm (or 3 mm to 7 mm) and/or an outer diameter in a range of 3 mm to 30 mm (or 6 mm to 14 mm).

In a refinement, the inner electrode conduit comprises stainless steel; the outer electrode conduit comprises stainless steel; the plurality of far electrodes comprises stainless steel; and the ground electrode comprises brass or steel.

In a refinement, each far electrode is spaced apart from the central electrode probe by a distance in a range of 0.5 mm to 10 mm (or 1 mm to 3 mm).

In a refinement, each far electrode is spaced apart from its adjacent far electrode or far electrodes by an angle in a range of a 2° to 40° (or 3° to) 20°.

In a refinement, the plurality of far electrodes is arranged in a circular arc relative to and concentric with the central electrode probe, the circular arc spanning at least 10° (e.g., 20° to 360°, 30° to 270°, 40° to 180° etc.).

In a refinement, the plurality of far electrodes has 2 to 200 (or 3 to 20) far electrodes.

In a refinement, the sensor further comprises an electrically insulating electrode carrier at the sensing surface, the electrode carrier being adapted to (i) retain the central electrode probe and the plurality of far electrodes in a selected spatial relationship between each other, and (ii) maintain electrical isolation between the central electrode probe, the plurality of far electrodes, and the ground electrode.

In a refinement, the sensing surface is a flat surface

In a refinement, the sensing surface is a curved surface (or a doubly curved surface).

In a refinement, the sensor further comprises a gas source in fluid communication with the gas delivery passage, the gas source being adapted to deliver (pressurized) gas at a controlled volumetric flow rate through the gas delivery passage and into an external liquid flow environment for gas bubble generation during use of the sensor. In other embodiments, the sensor more generally comprises a fluid source in fluid communication with the gas delivery passage, the fluid source being adapted to deliver a fluid such as a conductive liquid at a controlled volumetric flow rate through the gas delivery passage and into an external liquid flow environment for generation of an electrically conductive tracer during use of the sensor (e.g., salt or other dissolved ions in the liquid).

In a further refinement, the gas delivered by the gas source comprises (or is) air.

In a refinement, the sensor further comprises sensing electronics in electrical communication (e.g., electrically connected/coupled via suitable wiring) with the central electrode probe and the far electrode array, the sensing electronics being adapted to apply a voltage (e.g., sinusoidal or other AC signal) and sense a resulting impedance (i) between the inner electrode conduit and the outer electrode conduit, and (ii) between an individual far electrode and the ground electrode.

In a refinement, the sensor is mounted in a wall (or other structure) having an external (or liquid-contacting) surface such that the sensing surface of the sensor is flush with the external surface of the wall.

In another aspect, the disclosure relates to an aquatic vessel comprising:
a hull; and a sensor according to any of the variously disclosed aspects, refinements, embodiments, etc. mounted (i) within the hull and with the sensing surface being outwardly facing, and (ii) at a water-contacting position on the hull during operation of the aquatic vessel (e.g., below the water line of a boat or other surface vessel, such as on the main hull body or a foil component thereof; or anywhere on a submersible vessel).

In another aspect, the disclosure relates to a method for detecting one or more liquid flow properties, the method comprising: providing a sensor according to any of the variously disclosed aspects, refinements, embodiments, etc. with the sensing surface of the sensor in contact with a liquid flow environment in which liquid is flowing over the sensing surface (e.g., in a cross flow or otherwise generally parallel to the sensing surface); delivering a gas through the gas delivery passage a (controlled) volumetric flow rate sufficient to generate gas bubbles in the liquid flowing over the sensing surface; detecting the generated gas bubbles in the liquid flowing over the sensing surface with at least one of the central electrode probe and the far electrode array (e.g., via impedance measurements from the various electrode pairs); and determining one or more liquid flow properties in the liquid flowing over the sensing surface from the detected gas bubbles, the liquid flow properties being selected from the group consisting of wall shear stress, flow direction, flow speed, and combinations thereof.

Various refinements and embodiments of the disclosed method are possible.

In a refinement, the method comprises determining the wall shear stress.

In a refinement, the method comprises determining the flow speed.

In a refinement, the method comprises determining one or both of the flow direction and the flow speed.

In a refinement, the volumetric flow rate of the gas is in a range of 0.01 ml/hr to 10 ml/hr (or 0.1 to 2 ml/hr); and/or the liquid flowing over the sensing surface has a mean flow speed in a range of 0.1 m/s to 20 m/s (or 0.5 m/s to 10 m/s).

In a refinement, the liquid flow environment comprises water (or sea water/saltwater).

While the disclosed apparatus, methods, and compositions are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE FIGURES

FIG. 1 illustrates (A) a side cross sectional view of a sensor according to the disclosure during use, producing gas bubbles in a liquid flow environment; and (B) a bottom view of the sensor illustrating a central electrode probe and an array of far electrodes.

FIG. 2 illustrates a distribution of time-average velocity (u) as a function of normal distance (y) from the wall (u(y)) in a turbulent boundary layer (left) as well as the equations for wall shear stress (τ_{w}) and shear velocity or friction velocity (u*) (right).

FIG. 3 illustrates various views of a sensor according to the disclosure, including (A) an exploded top perspective view, (B) a top perspective view of an assembled sensor, (C) a bottom perspective view of an assembled sensor, (D) a top perspective view of a central electrode probe in the sensor, and (E) a bottom view of an electrode carrier and associated electrodes in the sensor.

FIG. 4 illustrates side views of a sensor according to the disclosure, including (A) a side cross sectional view of an assembled sensor, (B) a side view of an assembled sensor, and (C) an expanded side cross sectional view of a central electrode probe in the sensor.

FIG. 5 is a schematic illustrating a combination of a sensor or probe according to the disclosure with external sensing components, including sensing electronics for signal generation and data acquisition as well as an air delivery pump for bubble generation.

FIG. 6 is an electronics schematic for a central electrode pair in a sensor according to the disclosure in which the electrodes are driven in a single-ended arrangement.

FIG. 7 is an electronics schematic for a far electrode pair in a sensor according to the disclosure in which the electrodes are driven differentially using an invert-and-sum board.

FIG. 8 includes plots of raw central—(top) and far—(bottom) electrode signals (V) taken from the amplitude output of the lock-in amplifiers as a function of time (t) with a mean flow speed of 6 m/s and at a sensor angle of 0°.

FIG. 9 is a plot of average bubble detection fraction (three trials) over sensor clocking angle (degrees) as well as a univariate Gaussian fit applied to the averaged data.

FIG. 10 is a plot of bubble shedding rate (Hz) measured at the central electrode pair as a function of mean flow speed (m/s).

FIG. 11 is a plot of bubble shedding rate (Hz) measured at the central electrode pair as a function of near wall shear stress (Pa).

FIG. 12 is a schematic illustrating a sensing circuit for a sensor including central and far electrodes according to the disclosure.

### DETAILED DESCRIPTION

The disclosure relates to a sensor for detection and measurement of one or more of wall-shear-stress, near-wall flow-direction, and flow speed in wall-bounded liquid (e.g., water or otherwise) flows over curved or flat surfaces. As described in more detail below, the sensor utilizes small air bubbles (e.g., about 50 μm to 200 μm or about 10 μm to 500 μm diameter) produced at the sensor's concentric-electrode central orifice in a liquid cross-flow across the sensor's surface, an array of circumferentially distributed downstream surface electrodes, and electrical impedance changes induced by the small bubbles to determine bubble shedding rates and convection directions. For a fixed volumetric gas-flow rate, the bubble shedding rate is monotonically related to the wall shear stress, while the locations of the electrodes that record the bubbles' downstream impedance signatures indicate surface flow direction. The sensor can be implemented with a syringe or other suitable pump and low-cost custom electronics, and can operate at high bubble shedding rates, such as up to 10 KHz. Examples of other pumps include peristaltic pumps, diaphragm pumps, piezoelectric pumps, small piston pumps, etc. This sensing scheme can increase the accuracy and robustness of surface flow measurements while reducing their cost and difficulty.

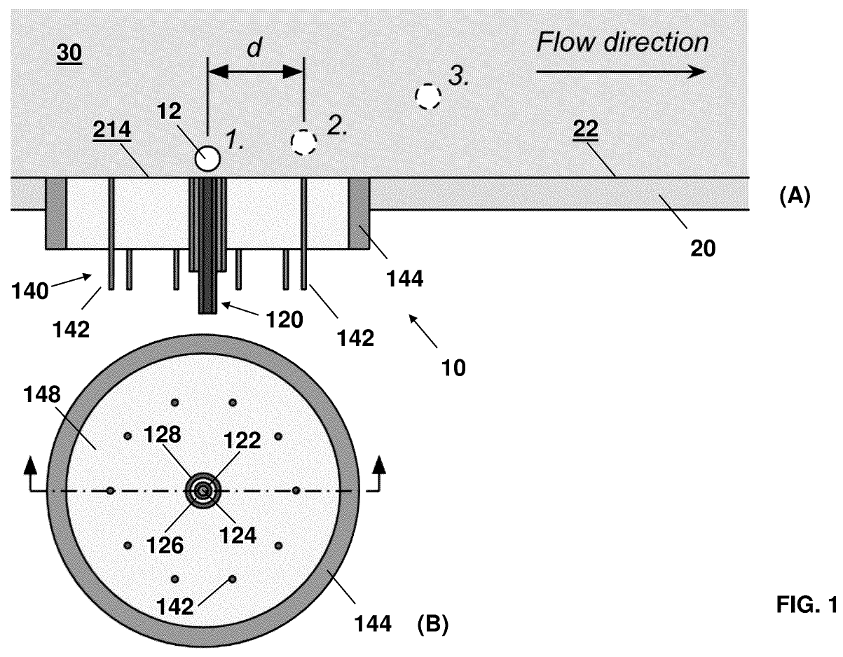

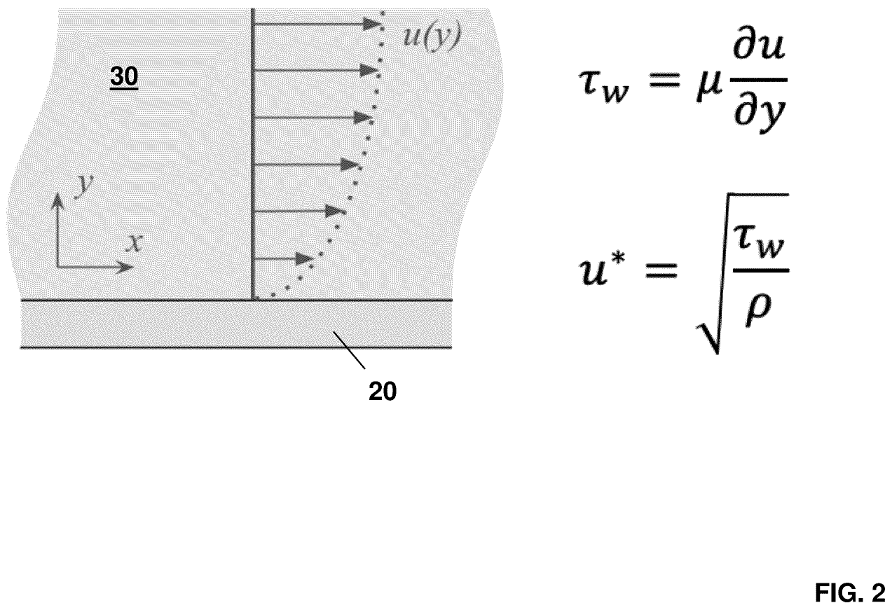

FIG. 1 and FIG. 2 illustrate the operating principle for liquid speed, direction, and wall shear stress measurement using a sensor 10 according to the disclosure. FIG. 1 illustrates (A) a side cross sectional view and (B) a bottom view of the sensor 10, for example being fitted or otherwise installed onto an object for sensing such that a bottom sensing surface 214 of the sensor 10 is flush with a wall or surface 20 of the object having the installed sensor 10. The bottom sensing surface 214 of the sensor 10 also faces and is in contact with a liquid flow environment 30 in which liquid (e.g., water or otherwise) is flowing over and generally parallel to the sensing surface 214 and wall 20. Bubbles (or microbubbles) 12 are produced at a central orifice 124 of an electrode probe 120. FIG. 1 illustrates three positions for a given bubble 12: Position #1 is where the bubble 12 is initially formed at the central orifice 124; position #2 is where the bubble 12 has been carried downstream a known distance “d” between the electrode probe 120 and a far electrode 142 (i.e., “d” is the spacing between the electrode probe 120 and the far electrode 142); and position #3 represents continued downstream flow of the bubble 12 in the liquid cross-flow of the environment 30. At position #1, the bubbles 12 are sensed by the electrode probe 120 using a concentric electrode pair, including an inner electrode 122 (e.g., stainless steel or other metal tube) and an outer electrode 128 (e.g., stainless steel or other metal tube) electrically insulated from each other via an electrical insulator 126 (e.g., a rubber, plastic, or other non-conducting sleeve). At position #2, the bubbles pass and are sensed by a far electrode pair in a far electrode array 140 located a known distance “d” away from the orifice 124. The far electrode pair is formed between a single far electrode 142 (e.g., electrode dot) and a surrounding ground ring 144 in the electrode array 140. The time of flight (TOF) for the bubble 12 between the central and far electrode pair is measured using impedance signals to detect the bubble 12 at each location, coupled with a measured time delay or lag between the detections for a given bubble 12.

As more particularly illustrated in FIG. 2, the exact surface shear stress is equal to the viscosity (μ) of the fluid multiplied by the length derivative of the velocity flowing parallel to the surface (du/dy). As the velocity measurement is taken at only a single height when the bubble 12 passes over the far electrode 142, the exact derivative cannot be calculated directly; instead, the shear stress (τ_{w}) can be determined based on the bubble time of flight or bubble shedding rate through an experimentally determined calibration. When the bubble trajectory remains within the inner portion of the boundary layer (e.g., in the log-layer or below), the bubble motion is self-similar based on the local shear velocity, and buoyant forces are negligible compared to shear induced lift, then the wall shear stress will be monotonically related to bubble TOF or bubble shedding rate. In this case, from channel flow tests, a relationship can be determined to produce a calibration curve relating bubble TOF or bubble shedding rate to near-wall shear stress.

Each bubble 12 is subject to a range of forces. The most significant forces are drag and surface tension, which scale with the square of velocity and inverse of bubble diameter, respectively. For a bubble 12 to release from the orifice 124, the force of drag must overcome the surface tension. This interaction results in a lower boundary for flow speed required for generating a bubble 12 (i.e., a single bubble shedding event). Accordingly, in various embodiments, the orifice 124 size (e.g., diameter) and/or the volumetric flow rate of air or gas through the orifice 124 of the sensor 10 can be selected or varied to adjust the resulting bubble diameter, which in turn can adjust or control a range of flow velocities over which bubbles 12 can be generated for detection by the sensor 10. Additionally, it is preferable to reduce or minimize the bubble size/diameter so that the bubble 12 remains within the sub-layer where flow characteristics are dominated by viscous effects and the shear stress information may reasonably be extracted. In embodiments, orifice 124 size and/or gas flow rate therethrough can be selected such that the resulting bubble 12 diameter can be in a range of 10 μm to 500 μm or 50 μm to 200 μm, for example at least 10, 20, 30, 40, 50, 60, 70, 80, 100, or 120 μm and/or up to 40, 60, 80, 100, 150, 200, 300, 400, or 500 μm. By way of illustration, for the sensor 10 described in the examples below, a typical bubble 12 diameter is about 200 μm to 250 μm at a cross-flow mean speed of 1 m/s and about 50 μm to 60 μm at a cross-flow mean speed of 6 m/s.

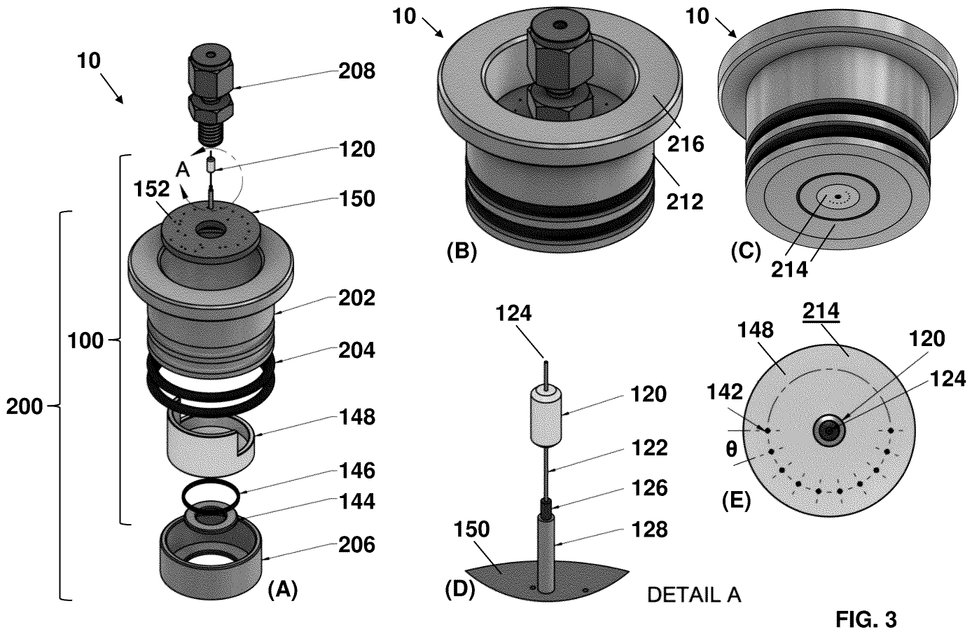

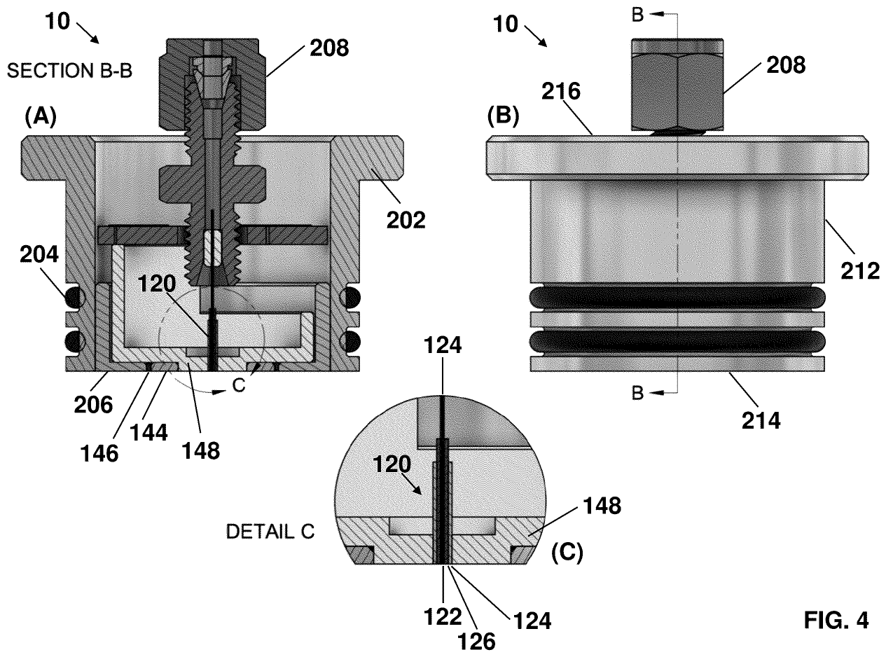

FIG. 3 and FIG. 4 illustrate several views of a sensor 10 according to the disclosure. The sensor 10 generally includes an electrode system 100 and a sensor housing 200. The electrode system 100 generally includes a plurality of electrodes for measuring electrical impedance generated by bubbles 12 or other dispersed or heterogeneously distributed phases or materials in a liquid flow environment 30 external to the sensor 10. The sensor housing 200 generally include mechanical and structural components for variously retaining electrodes in their desired spatial orientation in the sensor 10, mounting the sensor 10 into a wall 20 or other structure adjacent to the liquid flow environment 30 (see FIG. 1) for measurements, interfacing with external electric and electronic components for powering and sensing via the electrodes, and interfacing with external mechanical components for delivering gas or other materials for injection into the liquid flow environment 30.

The electrode system 100 includes a central (or interior) electrode probe 120 positioned within the sensor housing 200 and at a bottom or sensing surface 214 of the housing 200. The central electrode probe 120 includes an inner electrode conduit or tube 122 that is exposed at the sensing surface 214. The central electrode probe 120 also defines a gas or fluid delivery passage 124 through the sensor housing to the sensing surface 214. The gas or fluid delivery passage 124 can deliver air or other gas to the liquid flow environment 30 at a rate sufficient to generate the bubbles 12 in the external environment 30. In embodiments, the gas or fluid delivery passage 124 can deliver a fluid such as a conducting liquid. The central electrode probe 120 further includes an outer electrode conduit or tube 128 exposed at the sensing surface 214. The outer electrode conduit 128 is positioned around, spaced apart from, and electrically isolated from the inner electrode conduit 122. As illustrated, an electrically insulating sleeve 126 (e.g., formed from rubber or other insulating material) can be positioned between the inner electrode conduit 122 and the outer electrode conduit 128 to maintain electrical isolation between the two electrodes 122, 128 at the sensing surface 214 and/or within the housing 200.

As illustrated, the inner electrode conduit 122 and the outer electrode conduit 128 can be coaxially aligned, for example with both electrode conduits 122, 128 being in the form of or otherwise including cylindrical or tubular structures (e.g., with concentrically aligned circular cross sections at the sensing surface 214). A coaxial or other alignment in which the outer electrode conduit 128 is positioned around the inner electrode conduit 122 promotes bubble 12 detection of the central electrode probe 120 independent of the bubble's initial trajectory (e.g., in the x- or parallel direction relative to the sensing surface 214 and/or neighboring wall 20) as it enters the liquid flow environment 30. In embodiments, the inner electrode tube 122 can have a diameter in a range of 0.01 mm to 0.2 mm or 0.03 mm to 0.1 mm, for example at least 0.01, 0.02, 0.03, 0.05, 0.07, or 0.1 mm and/or up to 0.05, 0.07, 0.1, 0.15, or 0.2 mm, for example at the sensing surface 214. In embodiments, the outer electrode tube 128 can have a diameter in a range of 0.3 mm to 3 mm or 0.6 mm to 1.5 mm, for example at least 0.3, 0.4, 0.5, 0.6, 0.7, 0.8, 1, 1.2, 1.5, or 2 mm and/or up to 0.5, 0.7, 1, 1.5, 2, 2.5 or 3 mm, for example at the sensing surface 214. In embodiments, a gap or annular spacing between the electrode tube 122 and the outer electrode tube 128 (e.g., occupied by the sleeve 126) can be in a range of 0.2 mm to 3 mm, such as at least 0.2, 0.4, 0.7, or 1 mm and/or up to 0.8, 1.2, 1.5, 2, 2.5, or 3 mm. The foregoing diameter ranges and values can represent an inner diameter (ID) or an outer diameter (OD) of the respective tube. In embodiments where the inner electrode conduit 122 and/or the outer electrode conduit 128 have a geometry other than a cylindrical or tubular geometry, the foregoing ranges and values can represent an inner or outer hydraulic diameter (D_{H}) of the respective conduit (i.e., where D_{H}=4A/P based on the cross-sectional area A and perimeter P of the conduit).

In some embodiments, the electrode system 100 also includes a far (or exterior) electrode array 140 within the sensor housing 200 and at the sensing surface 214. The far electrode array 140 includes a plurality of far electrodes 142 exposed at the sensing surface 214. Each individual far electrode 142 is spaced apart from and electrically isolated from the other far electrodes 142 in the plurality as well as the central electrode probe 120 (e.g., electrically isolated from both electrodes 122, 128). The electrode array 140 also includes and a ground electrode or ring 144 exposed at the sensing surface 214. The ground electrode 144 is spaced apart from and electrically isolated from each individual far electrode 142 in the plurality as well as the central electrode probe 120 (e.g., electrically isolated from both electrodes 122, 128). In some embodiments, the sensor 10 can omit the far electrode array 140, for example having only a central electrode probe 120 to detect bubble shedding rate only at the center probe 120 for correlation with wall shear stress and/or flow speed, but without flow direction information from the far electrode array 140. When the far electrode array 140 is present, the sensor 10 can detect flow direction as well as wall shear stress and flow speed.

As illustrated, the far electrodes 142 can be in the form of electrode wires, and the ground electrode 144 can be in the form of a ring encircling the far electrode 142 wires. In embodiments, each far electrode wire can have a diameter in a range of 0.02 mm to 0.4 mm or 0.05 mm to 0.5 mm, for example at least 0.02, 0.03, 0.05, 0.07, or 0.1, or 0.2 mm and/or up to 0.05, 0.07, 0.1, 0.2, 0.3, 0.4, or 0.5 mm, for example at the sensing surface 214. In embodiments, the ground electrode 144 ring can have an inner diameter in a range of 2 mm to 20 mm (e.g., at least 2, 3, or 5 mm and/or up to 7, 10, 15, or 20 mm) and/or an outer diameter in a range of 3 mm to 30 mm (e.g., at least 3, 4, 6, or 8 mm and/or up to 14, 18, 24, or 30 mm). In embodiments where the far electrodes 142 and/or ground electrode 144 have a geometry other than a cylindrical or annular geometry, respectively, the foregoing ranges and values can represent an inner or outer hydraulic diameter (D_{H}) of the respective electrode.

The various sensor 10 electrodes can include or be formed from any metal or other electrically conductive material. For example, the inner electrode conduit 122 can be formed from stainless steel, the outer electrode conduit 128 can be formed from stainless steel, the far electrodes 142 can be formed from stainless steel, and the ground electrode 144 can be formed from brass. In general, electrode sensitivity would be suitable for various common conducting materials (e.g., copper, gold, silver, platinum, stainless steel, brass). An electrode material can be selected for its resistance to oxidation/reduction/tarnishing, which otherwise would reduce electrode sensitivity as it develops. The electrodes can reduce/tarnish more quickly because of the electricity passed through them through electrolysis. Stainless steel is useful because it is inexpensive and unreactive. Although comparatively more expensive, gold and platinum electrode materials are particularly suitable in terms of both electrode sensitivity and resistance to tarnishing.

The number of far electrodes 142 in the plurality is not particularly limited. In embodiments, the plurality of far electrodes 142 can be 2 to 200 or 3 to 20 far electrodes 142, for example at least 2, 3, 4, 5, 6, 7, 8, 9, 10, 12, 15, 18, or 20 and/or up to 4, 6, 8, 10, 12, 15, 20, 25, 30, 40, 50, 70, 100, 120, 150, or 200 far electrodes 142. A larger number of far electrodes 142 can improve spatial/directional resolution and sensitivity of the sensor 10, but it can also create a more crowded or otherwise complicated sensor 10 structure, in particular inside the sensor housing 200.

In embodiments, each far electrode 142 can be spaced apart from the central electrode probe 120 by a distance in a range of 0.5 mm to 10 mm or 1 mm to 3 mm, for example at least 0.5, 0.7, 1, 1.2 1.5 mm and/or up to 3, 4, 5, 6, 7, 8, 9 or 10 mm, for example at the sensing surface 214. The spacing can be uniform for each far electrode 142 when the far electrodes 142 are arranged concentrically in a circular or circular arc pattern relative to the central electrode probe 120. The spacing for each far electrode 142 can be different when the far electrodes 142 are arranged in a different pattern (e.g., square, straight or curved line, elliptical, or otherwise non-circular) and/or non-concentrically with the central electrode probe 120. In general, a sensor 10 with a circular, uniform-spacing far electrode 142 pattern can be convenient from a standpoint of ease of design or manufacture, the but the far electrode 142 arrangement can have any desired pattern and/or spacing density, for example a non-uniform far electrode 142 spacing with a higher far electrode 142 density in the direction of mean flow (or in an expected mean flow direction as the sensor 10 is mounted into a wall for sensing).

In embodiments, each far electrode 142 can be spaced apart from its adjacent far electrode(s) 142 by an angle θ in a range of a 2° to 40° or 3° to 20°, for example at least 2, 3, 4, 5, 6, 8, 12, 15, or 20° and/or up to 5, 7, 10, 12, 15, 20, 25, 30, or 40°, for example at the sensing surface 214. The angular spacing θ between a pair of far electrodes 142 can be defined as the arc or angle between two radial segments from the central electrode probe 120 and each far electrode 142 in the pair (see FIG. 3, panel (E)). The angular spacing θ can be uniform for each far electrode 142 pair when the far electrodes 142 are distributed evenly around the central electrode probe 120. In some embodiments, the angular spacing θ can be non-uniform for each far electrode 142 pair. For example, an individual angular spacing θᵢ can represent the angle between the i and i+1 far electrodes 142, such where consecutive far electrodes 142 are in a clockwise direction around the central electrode probe 120. For example, the sensor 10 can have a non-uniform angular spacing θ for some designs, such as including a higher angular electrode density in the expected flow direction for a given setting. In such cases, the sensor 10 can have at least some far electrodes 142 that are spaced apart by relatively smaller angles (e.g., 2° to 5°, 2° to 10°, or other sub-range from the above angles), and the sensor 10 can have at least some far electrodes 142 that are spaced apart by relatively larger angles (e.g., 10° to 40°, 10° to 20°, or other sub-range from the above angles).

In embodiments, the plurality of far electrodes 142 can be arranged in a circular arc relative to and concentric with the central electrode probe 120. Such a circular arc can span 10° to 360°, 20° to 360°, 180° to 360°, 30° to 270°, or 40° to 180°, for example at least 10, 20, 30, 40, 50, 60, 75, 90, 120, 150, or 180° and/or up to 40, 60, 90, 120, 150, 180, 270, 300, 320, 340, 350, or 360°. The circular arc can be expressed as the angular spacing between the first and last far electrodes 142 along the shortest arc that contains the other far electrodes 142 therebetween. Even when the far electrodes are distributed essentially around the entire circumference of their circular pattern, there is still a (small) angular gap between the first and last far electrode 142, so the upper bound on the circular arc is generally less than 360°.

As illustrated the sensor 10 can include an electrically insulating electrode carrier 148 at the sensing surface 214. The electrode carrier 148 retains the central electrode probe 120 and the plurality of far electrodes 142 in a selected spatial relationship between each other. The electrode carrier 148 also maintains electrical isolation between the central electrode probe 120, the plurality of far electrodes 142, and the ground electrode 144. The electrode carrier 148 can be formed form any suitable electrically insulating material, such as rubber, a non-conducting plastic or other polymer (e.g., polycarbonate), etc.

The particular structure, components, and materials of the sensor housing 200 are not particularly limited. The housing 200 components should provide sufficient internal space or volume to contain the various electrodes and corresponding wiring of the electrode system 100. The housing 200 components should also provide sufficient mechanical strength, mechanical seals (e.g., preventing liquid ingress to the housing 200 interior), and chemical resistance (e.g., resistance to corrosion or other fouling) for the intended liquid flow environment 30 of the sensor 10. As illustrated by way of example, the sensor housing 200 can include a cylindrical housing or enclosure body 202 defining an interior space for the electrode system 100 components, one or more o-rings (or other sealing/mounting means) 204 around the outer housing body 202, and an outer housing or enclosure bottom or base 206 coupled with or sealed to the housing body 202. The sensing surface 214 of the sensor 10 can be collectively defined by the external, environment-facing surfaces of the housing base 206, a ground isolation ring 146, the ground electrode 144, and the electrode carrier 148. The ground isolation ring 146 can be formed from a rubber or other electrically insulating material to ensure that the ground electrode 144 is also electrically isolated from the housing base 206 and other components of the housing 200 more generally. A top surface or region 216 of the housing 200 can include an overhang or flange to assist with mounting the sensor 10 in an external wall 20. The housing 200 can further include a breakout board 150 (or other electrically insulating retaining means) mounted near the housing 200 top surface 216. The breakout board 150 contains or defines a plurality of holes 152 through which the far electrodes 142, any electrical wires connected to the inner/outer electrode tubes 122/128, and any electrical wires connected to the ground ring 144 can be threaded and connected to external sensing electronics 310. The housing 200 can further include a fitting or mounting means 208 for retaining central electrode probe 120 and delivering air or other fluid for bubbles or other dispersed phase/material to be injected into the liquid flow environment 30.

The bottom or sensing surface 214 of the sensor 10 can be curved or flat, depending on its intended use setting. For example, the sensor 10 can be used in a flat or curved wall or surface to be monitored, such as where the sensing surface 214 conforms to or is otherwise flush with the shape/contour of the surrounding wall or surface 20 where the sensor 10 is installed. The sensor 10 can be initially manufactured with a flat sensing surface 214. Once installed into its desired sensing setting, the sensing surface 214 can be machined, polished, or otherwise reshaped so that the sensing surface 214 conforms to its surroundings. This is possible as long as there is sufficient material/structure remaining in the bottom of the sensor housing 200, the electrode carrier 148, etc. such that the sensor housing 200 remains sealed, and the electrodes 122, 128, 142, 144 remain exposed and are retained in their desired positions at the reshaped sensing surface 214.

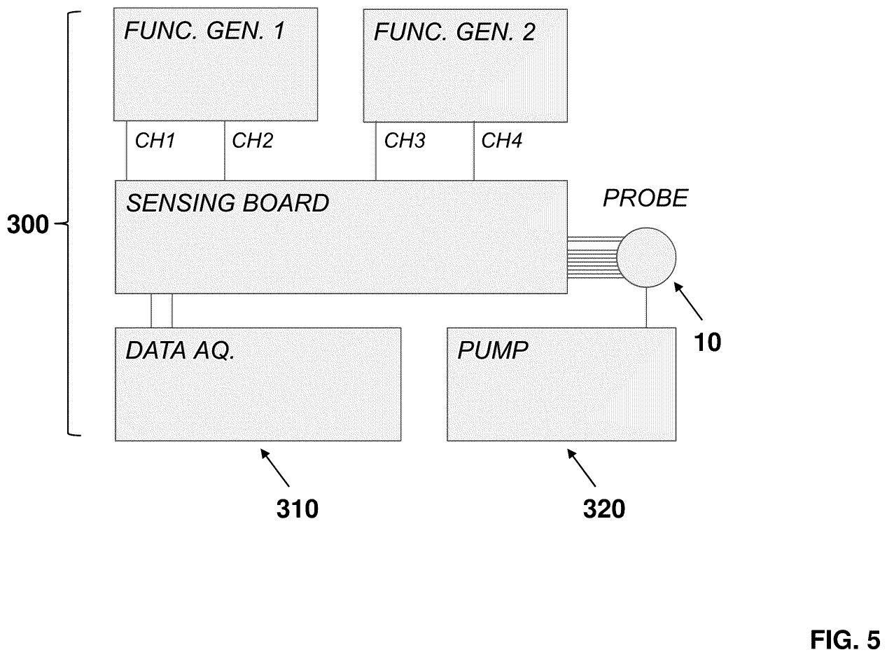

As illustrated in FIG. 5, the sensor or probe 10 can be incorporated into a sensing system having one or more external sensor components 300, for example including sensing electronics 310 and/or a gas source 320 (e.g., an air delivery pump) or other source/means for injecting or otherwise delivering a fluid into the liquid flow environment 30 via the delivery passage 124.

In embodiments, the sensor 10 or corresponding sensor system can further include a gas source 320 in fluid communication with the gas delivery passage 124 (e.g., directly connected or via suitable tubing or fluid flow conduits). The gas source 320 is adapted to deliver (pressurized) gas at a controlled volumetric flow rate through the gas delivery passage 124 and into the external liquid flow environment 30 for gas bubble 12 generation during use of the sensor 10. The gas source 320 is not particularly limited and can be any desired apparatus for storing, pressurizing, and/or delivered a controlled volumetric flow of gas or fluid more generally. The gas source 320 can include one or more of a syringe pump, an infusion pump, a cannister/cylinder containing compressed gas, a compressor providing compressed air or other gas, etc. For typical operating conditions of the sensor 10, the gas is suitably delivered at a controlled (e.g., essentially constant) volumetric flow rate in a range of 0.01 ml/hr to 10 ml/hr or 0.1 to 2 ml/hr, for example at least 0.01, 0.05, 0.1, 0.2, 0.3, 0.5, 0.7, 1, 1.5, 2, or 3 ml/hr and/or up to 0.8, 1, 1.2, 1.5, 2, 3, 5, 7, or 10 ml/hr. In a given setting, the flow rate can be selected to control resulting bubble formation (e.g., rapid bubble or singlet bubble formation as opposed to jetting or other non-bubble formation) and/or bubble characteristics (e.g., bubble size or diameter).

In embodiments, the gas delivered by the gas source 320 can be or otherwise include air. In some embodiments, the gas source 320 can deliver a gas other than air. If other downstream measurements may be sensitive to the bubbles 12, a gas highly dissolvable in water (e.g., carbon dioxide) may be selected so that the bubbles 12 disappear after they are produced and detected by the electrode system 100. Also, it is possible that a lighter or heavier gas relative to air may help the bubble 12 stay very close to the sensing surface 214 (e.g., depending on the sensor 10 orientation). In yet other embodiments, the fluid delivered and injected by the source 320 can be a liquid instead of a gas (e.g., the source 320 can more generally be a fluid source 320). For example, a highly electrically conductive liquid (e.g., salt water or water with a substantial amount of dissolved ions) can be injected into the liquid flow environment 30, and the difference or gradient in electrical conductivity properties between bulk liquid in the flow environment 30 and the injected liquid can be detected by the sensor 10 to measure flow direction alone at the far electrodes 142 (e.g., shear stress would not be sensed in the absence of shedding of bubbles or other discrete/dispersed phase). Similarly, an electrically non-conductive liquid (e.g., deionized water) can be injected into an electrically conductive liquid flow environment 30 (e.g., sea- or other saltwater), and the difference or gradient in electrical conductivity properties between bulk liquid in the flow environment 30 and the injected liquid still can be detected by the sensor 10 to measure flow direction at the far electrodes 142. Additionally, a dispersed or discrete phase other than gas bubbles can be injected into the flow environment 30 by the fluid source 320. For example, a mixture of water and small microspheres may be injected if it is desirable to keep the resulting size uniform across all flow speeds (i.e., where gas bubble size can vary with external liquid mean flow speed). The microspheres (e.g., made of glass or polymer; having a diameter generally corresponding to bubble size as disclosed herein) would act as the bubble and generate a similar impedance signature. In this case, a time-of-flight method could be used to find shear stress (i.e., in the absence of shear-induced bubble shedding for measurement/correlation). Yet further, a liquid that is immiscible with the bulk liquid in the flow environment 30 could be injected by the fluid source 320 to provide immiscible liquid droplets (e.g., similarly sized to the gas bubbles) dispersed in the liquid flow environment 30 that can be detected by the sensor 10.

In embodiments, the sensor 10 or corresponding sensor system can further include sensing electronics 320 in electrical communication with the central electrode probe 120 and the far electrode array 140, for example being electrically connected/coupled via suitable wiring within and external to the sensor housing 200. The sensing electronics 320 can apply a voltage (e.g., sinusoidal or other AC signal) and sense a resulting impedance (i) between the inner electrode conduit 122 and the outer electrode conduit 128, and (ii) between an individual far electrode 142 and the ground electrode 144. The sensing electronics 320 can include one or more function generators and/or power supplies for each of the central electrode probe 120 and the far electrode array 140, one or more lock-in amplifiers, filters, etc. that can be separate electronic components or integrated onto a sensing electronics board. The sensing electronics 320 can further include a data acquisition component for sensing/measuring the resulting impedance signals, as well as a computer with suitable memory, processor, storage, etc. for recording, storing, and/or processing the impedance signals. The computer system can similarly control operation of the sensor 10, for example controlling the delivery of gas or other fluid to the sensor 10 for bubble 12 or other discrete phase formation (e.g., via suitable electronics on the gas or fluid source 320 device), controlling application of voltage potentials between various electrode pairs, etc.

As mentioned above, the sensor 10 can be mounted in a wall 20 (or other structure) having an external (or liquid-contacting) surface 22 such that the sensing surface 214 of the sensor 10 is flush with the external surface 22 of the wall 20. The sensing surface 214 can be even or level with the wall external surface 22, for example collectively forming or being positioned on the same plane or other continuous curved, contoured, or flat surface. In some embodiments, the wall 20 or other structure to which the sensor 10 is mounted can be the hull or other water-contacting portion of an aquatic vessel (not shown). In such cases, the sensor 10 (or array of sensors 10 distributed at different hull locations) can be used to sense and record fluid flow parameters in the external flow environment 30 (e.g., ocean, sea, lake, river, or other aquatic or marine environment).

As described above, the sensor 10 can be used to detect one or more liquid flow properties in a liquid flow environment 30 in which liquid is flowing over and in contact with the sensing surface 214 of the sensor, such as in a cross flow or otherwise generally parallel flow direction relative to the sensing surface 214. A gas is delivered through the gas delivery passage 124 at a (controlled) volumetric flow rate sufficient to generate gas bubbles 12 in the liquid flowing over the sensing surface 214. The generated gas bubbles 12 are detected in the liquid flowing over the sensing surface 214 with one or both of the central electrode probe 120 and the far electrode array 140, for example via impedance measurements from the various electrode pairs in the electrode system 100. Various liquid flow properties, including wall shear stress, flow direction, and/or flow speed, can be determined from the electrical impedance measurements from the detected gas bubbles 12 in the liquid flowing over the sensing surface 214. The liquid flow over the sensing surface is generally a turbulent flow, but the sensor can also detect flow properties in laminar flow without sensor 10 modification. In general, the sensor data can be used to determine if the external liquid flow is laminar, turbulent, stagnant, separated, etc. As described above, in some alternative embodiments, a liquid can be delivered through the gas delivery passage 124 at a (controlled) volumetric flow rate sufficient to a form a heterogeneous difference or gradient in electrical conductivity properties and/or a liquid dispersed phase in the external environment 30, which in turn can create a detectable electrical signal that can be measured by the sensor 10 and correlated to one or more liquid flow properties.

In embodiments, the method can be used to determine the wall shear stress. For example, the wall shear stress can be determined based on a measured bubble shedding rate at the central electrode probe 120 and a corresponding correlation or calibration between the bubble shedding rate and wall shear stress.

In embodiments, the method can be used to determine the flow speed. For example, the flow speed can be based on a measured bubble shedding rate at the central electrode probe 120 and a corresponding correlation or calibration between the bubble shedding rate and flow speed.

In embodiments, the method can be used to determine one or both of the flow direction and the flow speed. For example, the flow properties can be based on a correlation between measured bubble events in an impedance time series at the central electrode probe 120 and an impedance time series at one or more far electrode 142/ground electrode 144 pairs. The flow direction can be determined from the far electrode 142 signal with the highest correlation to the central electrode probe 120 signal (or the peak of a Gaussian or other fit to the correlation values for the different far electrodes). The flow speed can similarly be determined based on a time-of-flight measurement as the lag time between the central electrode probe 120 signal and the far electrode array 140 signals providing the highest correlation, coupled with a known distance between the central probe 120 and the far electrodes 142.

In embodiments, the volumetric flow rate of the gas or fluid can be in a range of 0.01 ml/hr to 10 ml/hr or 0.1 to 2 ml/hr. For example, the volumetric flow rate of the gas or fluid can be at least 0.01, 0.05, 0.1, 0.2, 0.3, 0.5, 0.7, 1, 1.5, 2, or 3 ml/hr and/or up to 0.8, 1, 1.2, 1.5, 2, 3, 5, 7, or 10 ml/hr.

In embodiments, the liquid flowing over the sensing surface has a mean flow speed in a range of 0.1 m/s to 20 m/s or 0.5 m/s to 10 m/s. For example, the mean flow speed can be at least 0.1, 0.2, 0.3, 0.5, 0.7, 1, 1.5, 2, 3, 4, or 5 m/s and/or up to 4, 6, 8, 10, 12, 15, 18, or 20 m/s.

In embodiments, the liquid flow environment 30 can include or be water (or sea water/saltwater). More generally, the liquid flow environment 30 can include any aqueous and/or non-aqueous liquid having a sufficiently low viscosity to permit bubble 12 formation upon gas ejection from the sensor 10.

### EXAMPLES

The following examples illustrate the disclosed sensor and related methods, but are not intended to limit the scope of any claims thereto. In the following examples, a sensor according to the disclosure was constructed and its ability to resolve wall shear stress and flow direction were tested. Bubble time of flight and bubble shedding rate were determined through impedance measurements at discrete flow speeds ranging from 1 to 6 m/s. Bubble detection fraction was measured at a constant channel flow speed of 2 m/s for angles from −25° to 20°. High-speed video was collected to determine actual bubble speed as a reference. The results indicate that wall shear stress, flow speed, and flow direction detection are possible and robust. For flow direction, the sensor provides a higher angular detection resolution than is provided by the discrete electrode spacing can be achieved through curve fitting.

### Example 1—Flow Loop and Sensor Design and Operation

Testing Flow Loop: Testing was performed in a closed channel high speed flow loop having a channel flow zone 1.14 m in length and 7 mm in height. The test liquid flowing through the loop was tap water roughly maintained at about 20° C. For each test, the sensor was inserted into a top channel window. Using a mirror and telescopic macro lens, the sensor face was imaged from below the channel through a bottom window. Bubbles were produced at the sensor's central orifice using a syringe pump delivering air at a controlled, constant volumetric flow rate, and bubble formation and convection were captured using a high-speed camera. In addition, the bubble impedance signal was measured using test electronics at both the sensor's central and far electrodes. The flow is tripped by sandpaper strips as it enters the channel so that the probe lies well within the turbulent boundary layer.

Sensor Design: A sensor as generally illustrated in FIG. 3 and FIG. 4 was assembled. The diameter of the far electrodes 142 was 0.102 mm, the far electrodes 142 were spaced a radial distance d of 1.59 mm away from the central probe 120, the angular spacing θ between adjacent far electrodes 142 was 20°, the diameter of the ground ring electrode 144 was 10.7 mm (OD) and 5.84 mm (ID), the inner diameter of the inner electrode tube 122 was 0.06 mm (=orifice 124 diameter), and the outer diameter of the outer electrode tube 128 was 0.81 mm. The inner electrode tube 122 diameter of 0.06 mm provided bubbles 12 nominally 0.25 mm in diameter at a channel tunnel flow speed of 1 m/s and an air flow rate of about 0.75 ml/hr. As illustrated in FIG. 3 (panel (E)), the sensor 10 included ten far electrodes 142 spanning a 180° arc. This is sufficient when the flow environment 30 has a generally known cross-flow direction and the sensor 10 is oriented/aligned with one or more of the far electrodes 142 generally in a downstream direction relative to the central probe 120. In other embodiments (not shown), the sensor 10 can include a plurality of far electrodes 142 spanning essentially the entire 360° circumference or perimeter around the central probe 120.

The sensor 10 included brass components for the housing body 202, the housing base 206, the fitting 208, and the ground ring electrode 144. The sensor 10 was constructed using 304 stainless steel wire for the far electrodes 142, stainless steel needles for the coaxial inner electrode tube 122 (which defines the orifice 124) and outer electrode tube 128, and polycarbonate for the electrode carrier 148. The electrode carrier 148 is an electrically insulating structure in which electrodes are inserted and fixed using epoxy for controlled spacing relative to each other (e.g., controlled radial distance d between the central electrode probe 120 and individual far electrodes 142, controlled angular spacing θ between adjacent far electrodes 142). Electrode wires were shrink wrapped with an insulating jacket, threaded through holes 152 of the breakout board 150, soldered to the board 150, and were connected to the external sensing electronics along with the coaxial electrode tubes. The sensor 10 further included sealing o-rings 204, a ground isolation ring 144, and a depth-registering flange at the housing top surface 216.

Sensing Electronics: Two Stanford Research SR830 lock-in amplifiers, two Keysight EDU33212A waveform generators, one Tektronix DPO 3014 oscilloscope, one Keysight EDU36311 power supply, and one Phantom v1212 high speed camera were used in this example. In addition, a board was developed and constructed to drive the far electrode pair. For some measurements, the separate SR830 lock-in amplifiers were not used; instead, lock-in amplification was performed using an Analog Devices AD630 balanced modulator/demodulator chip incorporated onto the electronics board.

Bridge Circuit: Bubbles are sensed as they pass over an electrode pair through changes in impedance. This is achieved using a function generator, lock-in amplifier, and bridge circuit. The function generator injects a sinusoidal carrier signal into the top node of the bridge. One leg of the bridge consists of the probe and a stable sensing resistor, and the other leg is substituted by a phase- and amplitude-adjusted signal. This signal is supplied by the second channel of the function generator, and is phase- and amplitude-shifted with respect to the carrier signal. In this way, the bridge can be zeroed by adjusting the phase and amplitude of the second channel nulling signal. The differential between the two legs is measured using the lock-in amplifier. A lock-in amplifier was selected for its excellent noise rejection and ability to extract minute signals from background noise magnitudes larger than the desired content. The sensing resistor was selected experimentally to maximize the bridge differential when a bubble passes over the electrode pair. Too large or small of a resistance yields poor sensitivity. By selecting a resistance to match the impedance of the probe at the carrier signal frequency, good sensitivity was achieved. The resistance can then be adjusted to tune the linearity and sensitivity of the system. Vishay metal foil resistors were selected for their low noise and excellent stability.

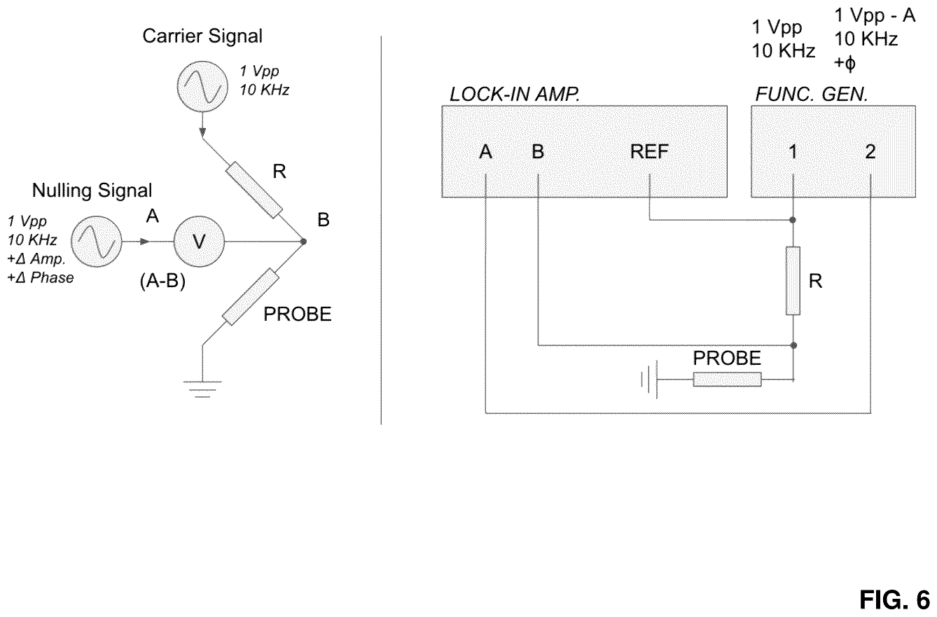

Central Electrode Circuit: The central probe 120 and far electrodes 142 use different sensing circuits: The central probe 120 electrodes yield a high signal-to-noise ratio due to their physical arrangement—they are close to one another and are coaxial, and as such, the current produced at the central electrode is overwhelmingly sunk to the surrounding ground. It was found that a simple half Wheatstone bridge was sufficient for this central probe 120 electrode pair. The central electrode is driven with the carrier signal, and the outer electrode is simply grounded. FIG. 6 illustrates the electronics schematic for the central probe 120 in which the electrodes are driven in a single-ended arrangement.

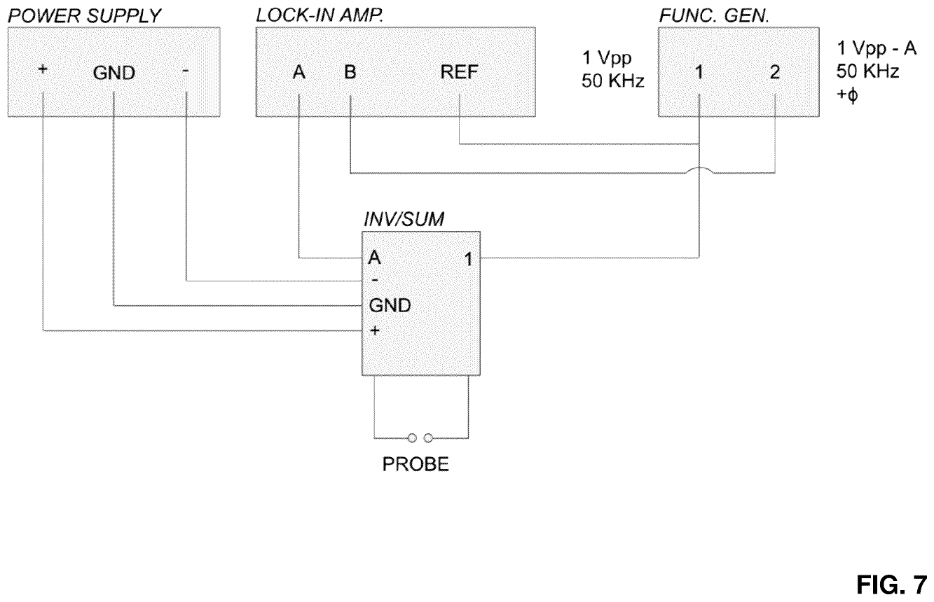

Far Electrode Circuit: The far electrode pair, formed between a far electrode dot 142 and a large ground ring 144, is much more susceptible to noise. Due to the comparatively large distance between the electrodes, in a single ended arrangement, the carrier signal disperses and little current reaches the ground. As such, a passing bubble 12 disrupts little of the electromagnetic field, and a weak impedance bump is produced. To solve this problem, both the source and sink are driven: Instead of relying on the potential between the source electrode and ground, the ground is driven with the same signal as the source electrode, 180° out of phase. This actively draws the current to the sink, and results in less current loss to the surroundings (which are at ground potential). In addition, the signal from both the source and sink electrodes can be combined to yield a stronger input to the lock-in amplifier. This sensing method is shown in the electronics schematic of FIG. 7. To drive the source and sink electrodes out of phase from one another and combine the generated signal, a custom board was designed. The carrier signal is input to the board, and is inverted using an opamp. The uninverted signal is passed through a voltage follower constructed using the same opamp to make the unwanted phase change and distortion of the two signals comparable. The inverted and uninverted signals are then passed through separate but matched resistances to form one leg of the bridge circuit. Voltage followers are included after the resistances and before the electrodes to isolate the sensing resistors from the ‘summing’ opamp. A final opamp is used to subtract the two signals, effectively summing the electrode signal.

Data Processing: Using MATLAB, the impedance signals from the central and far electrode pairs are recorded to separate channels. Data is processed after the entire file has been written. To determine the number of bubble events at either electrode pair, a threshold value is first defined: it is taken to be the average signal amplitude divided by a factor of six. This produces a threshold value above the noise floor of the signal. The number of peaks detected that exceed this threshold are then computed. To determine the bubble time of flight, the cross correlation between the central and far electrode signals is computed. TOF is taken to be the time lag at the maximum correlation value (within reasonable bounds). To increase the accuracy of this method, only data before and slightly after each far electrode peak is extracted for the cross correlation. In this way, only data with confident bubble events are considered for the TOF computation. Raw correlations are computed with no normalizations. Data is collected at a sampling rate of 125 ks/s for each channel.

Speed-Resolved Bubble Data: Time of flight was measured at discrete flow speeds ranging from 1 to 6 m/s. Flow speed was incremented by 0.1 m/s per step from 1 to 1.5 m/s, and 0.5 m/s per step from 1.5 to 6 m/s. In addition, the number of bubbles produced and the number of bubbles detected were also determined at each tested speed. From these data, the detected bubble fraction and an approximate bubble shedding frequency were determined. Three trials 30 seconds each were collected at each flow condition. Between each trial, the bridge was nulled to maximize detection sensitivity, and the flow was left to stabilize between each speed.

Angle-Resolved Bubble Data: The sensor was clocked to an arbitrary angle near 0 degrees, and this orientation was taken to be the zero point. The channel mean flow speed was set to 2 m/s, and the number of bubbles produced and detected were determined at discrete angles from −25° to 20°. The sensor angle was incremented by 2.5° from −10° to 10°, and by 5° from ±10° to ±20/25°. From these data, the detected bubble fraction was calculated as the number of bubbles detected by the far electrodes divided by the number of bubbles detected at the central electrodes. Three trials of 30 seconds each were collected per angle. Again, the bridge was nulled between each trial.

High Speed Videography: Video was collected at a frame rate of 10,000 fps using a Phantom v1212 camera. 500-frame video segments were recorded at flow speeds ranging from 1 to 6-m/s at increments of 0.5 m/s. From these video files, approximate bubble speed was determined. Five random bubble events were analyzed at each speed. Bubble speed was averaged from the outer central electrode to the edge of the video frame. A free, open-source program (“Tracker”), was used to determine bubble speed.

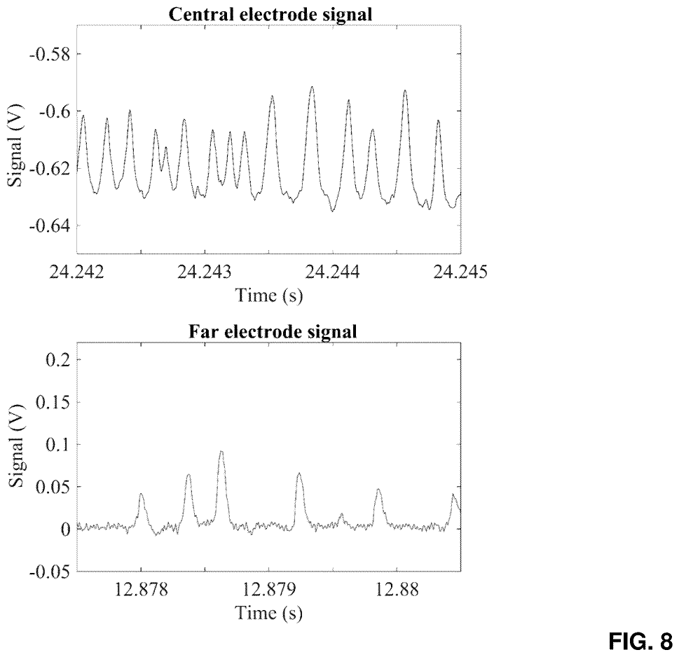

Electrode Impedance Data: FIG. 8 includes plots of raw central-(top) and far-(bottom) electrode signals (V) taken from the amplitude output of the lock-in amplifiers as a function of time (t) with a mean flow speed of 6 m/s and at a sensor angle of 0°. Each peak in the signal represents a bubble event. There are significantly more bubble events detected at the central electrode pair than the far electrode pair. This is due in part to the variation in trajectory of each bubble produced. Due to the electrode arrangement, bubbles are not detected unless they pass directly over an electrode dot. However, this does not account for all of the bubbles left undetected. This effect is further evaluated by varying the angle of the sensor with respect to the mean flow direction as discussed below. Bubble time of flight (TOF) is determined from cross correlation plots, where the TOF is taken to be the lag value at which the maximum cross correlation is computed between the central electrode signal and the far electrode signal.

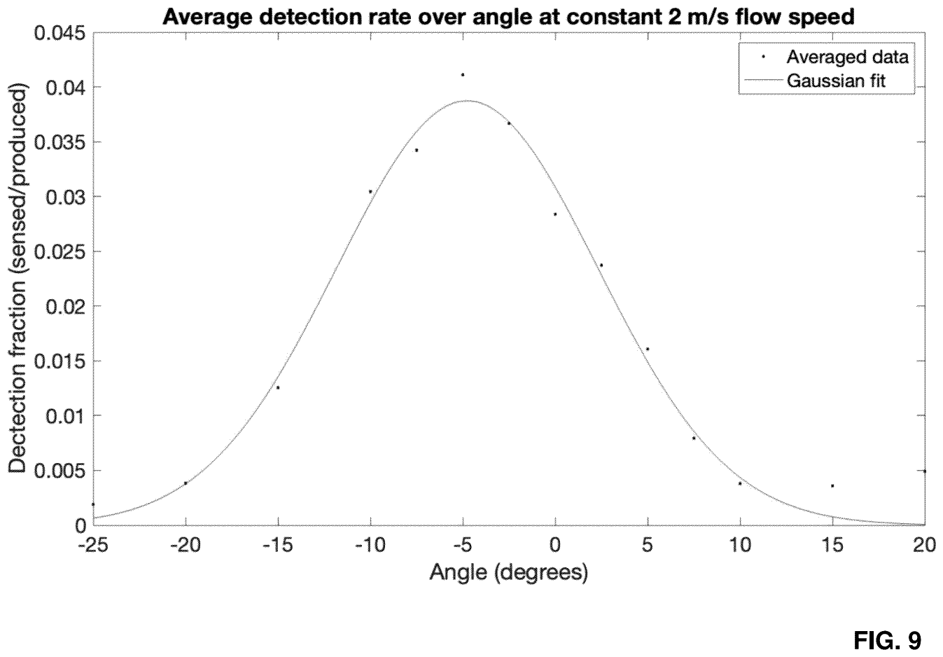

Angle-Resolved Data: From trial to trial, the detection fraction at each discrete angle for a given far electrode is relatively consistent. Each data set produces a fairly symmetrical distribution, and a univariate Gaussian fit matches well to the average data. With an angular resolution of 5°, a clear distribution is evident. FIG. 9 is a plot of average bubble detection fraction (three trials) over sensor clocking angle (degrees) as well as the univariate Gaussian fit applied to the averaged data. From these data, it appears that the initial clocking angle is approximately −5° off from the true mean flow direction.

Although the distribution looks reasonable, the fraction of detected bubbles does not account for all bubbles. Summing the average detection fractions for all angles, about 21% of the total number of bubbles produced were directly detected using the sensor. Similarly, integration of the Gaussian fit to the detection fraction distribution accounted for about 68% of the total bubbles produced. The remaining bubbles most likely remain undetected because the amplitude of their signal is below the set threshold. Notwithstanding the detection of less than all of the bubbles generated, the data indicate that the sensing electronics are capable of resolving flow angle when a sufficient number of downstream electrodes are present. It was found that at flow speeds of 1 m/s and 2 m/s, the vast majority of the bubble distribution is captured in a 40° arc. Increasing the angular density of the far electrodes can further increase data certainty and angle/flow direction resolution.

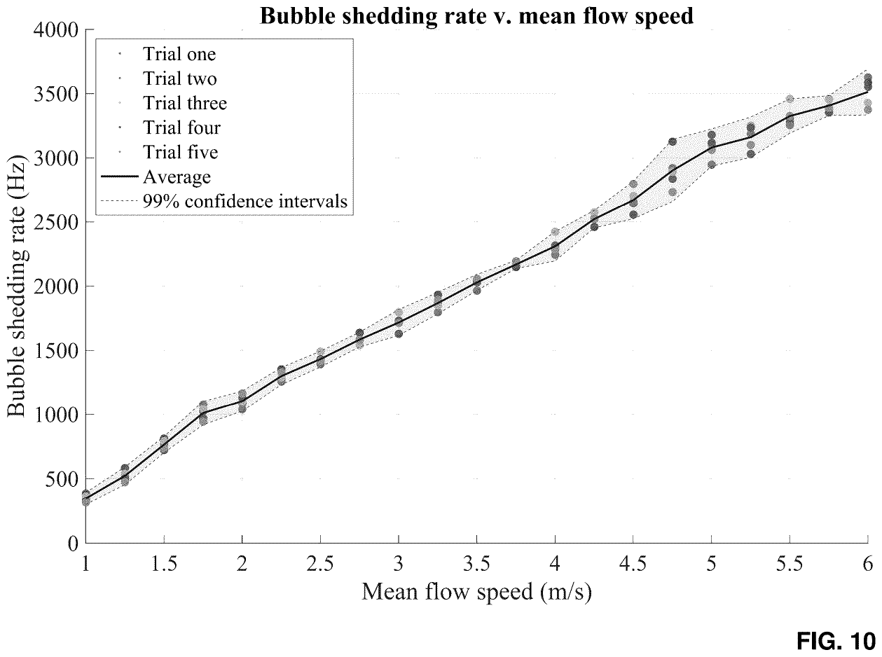

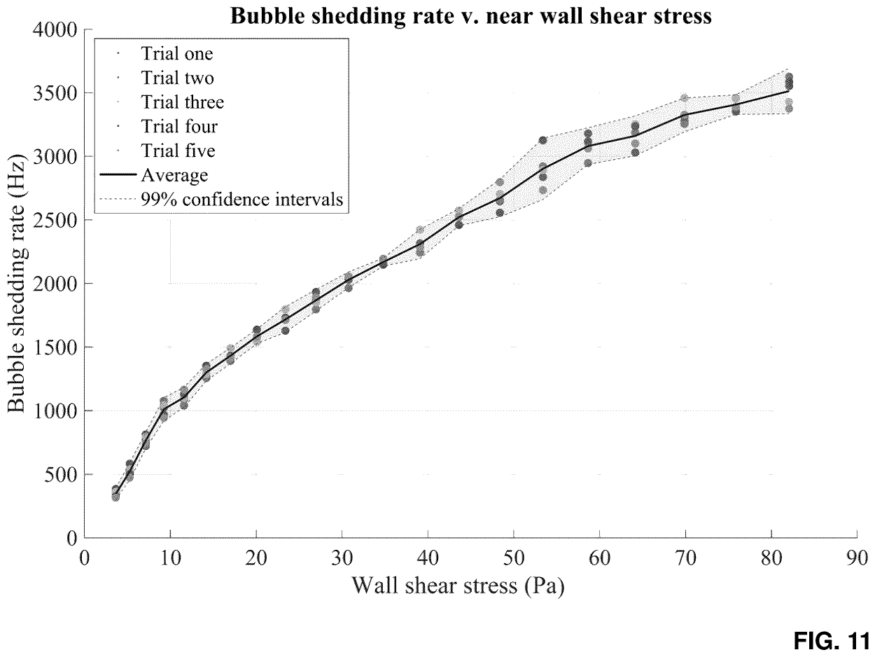

Speed and Wall Shear Stress Data: FIG. 10 is a plot of bubble shedding rate (Hz) measured at the central electrode pair as a function of mean flow speed (m/s) in the test channel flow. FIG. 11 is a plot of bubble shedding rate (Hz) measured at the central electrode pair as a function of near wall shear stress (Pa) in the test channel flow. The wall shear stress was derived from static pressure tap measurements and the known relationship between wall shear stress (τ_{w}) and pressure gradient (dp/dx) for fully developed turbulent channel flow with a constant channel height (h): τ_{w}=−(h/2)(dp/dx). These data indicate that a bubble shedding rate measured at the central electrode probe can be used to determine one or both of the wall shear stress and flow speed in the liquid cross-flow environment external to the sensor. It is believed that the relationship between bubble shedding rate and the wall shear stress can be independent of the external environment flow geometry as long as the bubbles are appropriately sized to remain in the inner portion of the external flow boundary layer (e.g., in the log-layer or below) during the portion of their trajectory that is detectable by the sensing electrodes. The unique correspondence between mean flow speed and wall shear stress as a function of bubble shedding rate can be a result of the specific channel flow test apparatus used. For other flow geometries, a different bubble shedding rate vs. mean flow speed calibration can be experimentally determined using the sensor, or mean flow speed can be determined using TOF measurements between the central electrode probe and the far electrode array.

### Example 2—Upgraded Sensing Electronics

In Example 1, Stanford Research SR830 lock-in amplifiers were used to extract electrode impedance signals. However, their large size and high cost can limit their use in cases where multiple sensors are to be used or a fully integrated solution is desired. In this example, a custom sensing board has been developed as a replacement and upgrade. This board offers improved sensitivity, cost, resolution, and size, and enables sensor installation in a closed model.

Circuit Overview: The circuit senses and amplifies the impedance signal at an electrode pair to enable bubble detection through digital processing. The circuit generates a sinusoidal voltage potential across an electrode pair. When a bubble passes over the electrodes, the impedance at the pair increases. This change in impedance is detected using a Wheatstone bridge. The voltage difference across the bridge is extracted using lock-in amplification. Two of these bridge and lock-in amplification circuits are included on the board. One is used to detect the impedance at the central electrode pair, and the other is used to detect the impedance at each of the far electrodes. As a single detection circuit is only capable of measuring a single electrode pair at once, a multiplexer is used to iterate through each of the far electrodes.

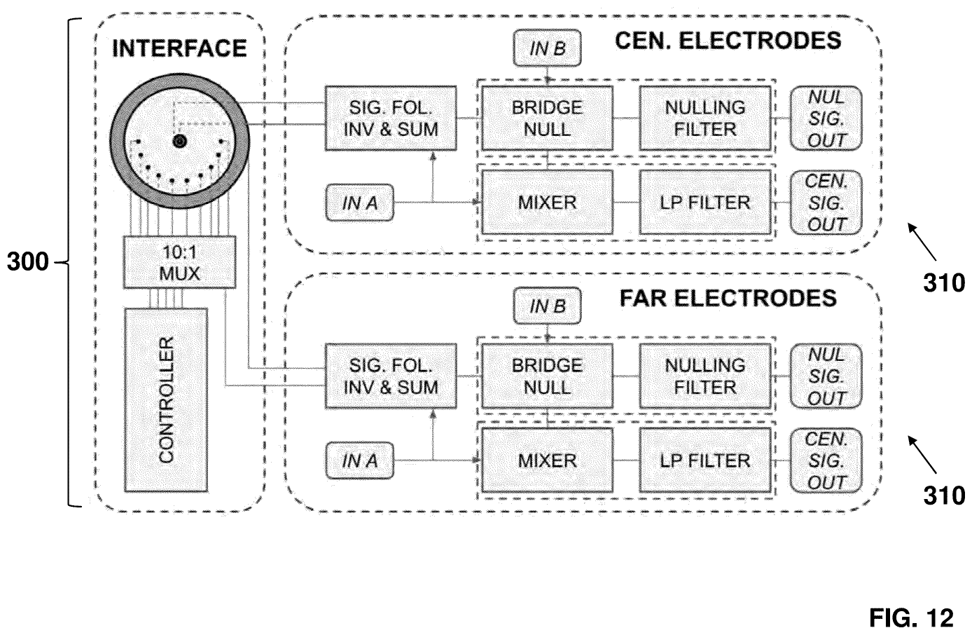

A high-level diagram of the entire sensing circuit is included in FIG. 12, which includes a functional diagram of a sensing circuit 300 including all major subcircuits 310. The interface connects the sensor to the board and contains the multiplexing chip and microcontroller. The far and central electrode sensing circuits are identical. The bridge circuit consists of the bridge nulling stage and nulling filter and are presented in the same section below. The lock-in amplification stage consists of both the mixer and low-pass filter and are similarly presented together. Each detection circuit is composed of five subcircuits: 1) an electrode signal inversion, follow, and sum stage, 2) a bridge nulling stage, 3) a nulling filter, 4) a mixing stage, and 5) an output filter and amplifier.

Far Electrode Multiplexing: To measure flow direction, bubble detection is performed at several downstream electrode pairs. To take measurements at multiple pairs using a single mixing chip, an analog multiplexer is used. The ground ring is shared as a common second electrode for each downstream pair. Therefore, to achieve multiplexing, it is only necessary to cycle through the 10 electrodes making up the outer ring. To do so, a MUX506IPWR 16:1 precision analog multiplier is used. It is controlled digitally with a SEED XIAO microcontroller board.

Signal Inversion, Following, and Summing: To increase the signal-to-noise ratio (SNR) of the measured impedance, the electrode pairs are driven differentially which results in less current loss to the surroundings at ground potential. The signal from each electrode is combined to yield a stronger input to the mixing stage. The input to this circuit is a sinusoidal waveform with a peak-to-peak amplitude of 1V, frequency of approximately 400 kHz, and phase of 0°. This input signal is split to drive the electrodes 180° out of phase. To do so, one branch is inverted, and the other is buffered using a Texas Instruments LMH6628 op-amp. The inverted and uninverted signals are passed through separate but matched resistances to form one ‘leg’ of the bridge circuit. A Texas Instruments INA849 instrumentation amplifier is used to subtract the two signals, effectively summing the signal from both electrodes. This signal is then fed into the bridge.

Bridge Circuit and Nulling Filter: The heart of the circuit is a modified Wheatstone bridge. The bridge is used to convert the change in impedance at the electrode pair into a measurable voltage. One leg of the bridge consists of the circuit described above, and the other leg is substituted by a phase- and amplitude-adjusted signal. This signal is supplied by the second channel of the function generator and is phase- and amplitude-shifted with respect to the carrier signal. In this way, the bridge can be zeroed by adjusting the phase and amplitude of this signal. The proximity of the bridge to its null condition is reflected by the amplitude of the bridge output signal. A 10 KHz high pass filtered version of the bridge output is monitored to null the bridge. The phase and amplitude of this signal is adjusted until the amplitude of this signal is nearly zero. The high pass filter serves to remove DC offset and very low frequency noise. The difference between the two legs is measured using a lock-in amplification circuit. The sensing resistor value is selected experimentally to maximize the bridge sensitivity. By matching the resistance with the impedance of the probe at the carrier signal frequency, the bridge sensitivity can be maximized. The resistance can then be adjusted to tune the linearity of the system. Vishay metal foil resistors were selected for their low noise and excellent stability.

Lock-In Amplification—Mixing and Filtering: Lock-in amplification is implemented for its ability to extract minute signals from background noise. A lock-in amplifier consists of a phase sensitive detector (PSD) and a low pass filter. In this circuit, an Analog Devices AD630 modulator chip is used as the PSD, and a hybrid passive and active bandpass filter and amplifier is used to condition the output signal. The carrier signal and bridge circuit output are fed into the AD630 chip and synchronously mixed. The resulting chip output signal consists of two components: 1) mixed carrier signal and system noise, and 2) low frequency content containing the phase and amplitude information of the two input signals. The impedance signal is recovered by applying a low pass filter to the AD630 output. In addition, a passive single-pole high pass filter is applied via AC coupling to remove any DC offset introduced by imperfect nulling, and a 10 dB gain stage is implemented using an instrumentation amplifier to increase the amplitude of the output signal.

### Example 3—Pumping Apparatus

In Example 1, a syringe pump was used to deliver air at a controlled, constant volumetric flow rate for bubble formation. A syringe pump, however, can be bulky and can be limited in the time duration over which it can provide constant flow. In this example, additional pumping apparatus are evaluated for comparison with the syringe pump, including a peristaltic pump, and a piezoelectric diaphragm pump, both of which are available in miniature form and can supply gas at a constant volumetric rate. In the disclosed sensor apparatus, the volumetric flow rate of the pump should be insensitive to the pressure at the orifice. This ensures that the bubble shedding rate is not influenced by static pressure so that a shear stress estimation can be made without the need for pressure-based correction.

To characterize each pump, the sensor was installed into the top window of the flow loop as usual, and the pump in question was connected to the orifice. The mean flow speed of the channel was maintained at a constant 3 m/s, and the static loop pressure was increased in increments of approximately 0.5 psi from atmospheric pressure to a value 4 psi greater than the atmospheric pressure. One 100 second trial was collected at each pressure. This same procedure was repeated for all three pumps. Additionally, the static pressure at the orifice was measured at flow speeds of 0 to 6 m/s at increments of 0.5 m/s. An Omega PX419-030A10V-EH pressure transducer was used to measure the absolute channel static pressure at the location of the orifice via a 1/32 in tap in the channel side window. The average pressure over the measurement period of 100 seconds is reported. The syringe pump was refilled with air and given five minutes to stabilize between each condition to ensure steady bubble production. Similarly, the peristaltic pump was left for five minutes after each flow or pressure adjustment to ensure that the orifice and channel pressure had adequate time to reach equilibrium.

Shear-Stress Resolved Bubble Data: Bubble shedding rate was measured at discrete flow speeds ranging from 1 to 6 m/s at increments of 0.5 m/s. Five trials of 100 seconds each were collected at each flow condition. This process was performed on five separate days with the setup completely disassembled and reassembled between each repetition to allow for the analysis of measurement repeatability. To present these results with respect to known wall shear stress, the average shear stress was calculated at each speed using static pressure collected at 10 taps located along the length of the channel side window. The length derivative of the pressure along an axis parallel to the wall (dp/dx) was approximated using the known distance between each tap. From the known channel height (h), the wall shear stress (Tw) was calculated as τ_{w}=(h/2)(dp/dx)⁻¹.

Angle Resolved Bubble Data: Angle resolved bubble data were collected at channel mean flow speeds of 1, 3, and 5 m/s. At each speed, three clocking angles were tested. Both far and central electrode pair signals were recorded at each of the nine conditions, and the far electrodes were multiplexed at a switching rate of 10 seconds per electrode. A total of five 100 second trials were recorded at each condition. Bubble detection fraction was calculated from these data and a univariate Gaussian fit was applied to estimate flow direction as described above. A five-second-long exposure photo of the sensor face was taken at each condition from which the average bubble angle was extracted for comparison to the impedance-derived angle.

Results: In the specific flow system tested in this example, the piezoelectric pump did not produce enough pressure to generate bubbles during channel testing. Accordingly, only the peristaltic pump was further evaluated for comparison with the syringe pump. The peak-to-peak amplitude of the central impedance signal remains constant when the syringe pump is used to supply air to the sensor. The amplitude is steady across the entire trial length at each speed. The syringe pump provides an extremely constant pressure and volumetric flow rate through a piston-displacement action. The amplitude does not remain constant when the unmodified peristaltic pump is used. At a flow speed of 1 m/s, the pump periodically generates bubbles, but there are regular intervals during which no bubbles are produced. At a 3 m/s mean channel flow speed, bubbles are nearly always produced (with occasional breaks), but the shedding rate at the orifice fluctuates slowly at a constant frequency. At 6 m/s, bubbles are generated without any breaks in production, but the shedding rate still fluctuates at the same frequency as observed before. This variation in bubble shedding rate is due to the intermittent pumping action of the peristaltic pump. Rollers push gas through a deformable tube to generate flow. When a roller reaches the end of the guide against which it pushes, there is temporarily no flow. This is especially significant when the rotor is spinning slowly. At 2 RPM, one of the rotor's five rollers passes over the guide end every 6 seconds. This frequency is consistent with the period of fluctuation observable in the data above.

To smooth out the gas flow provided by the peristaltic pump, a 50 mL reservoir was added at the outlet. This provides a buffer for pressurized gas to accumulate in that can be drawn upon when the pump is not providing flow. Using the reservoir, at a flow speed of 1 m/s, the pump always produces bubbles and there are only slight fluctuations in the shedding frequency. At 3 m/s, bubbles are produced at a nearly constant rate. At 6 m/s, bubbles are produced with no fluctuations. This demonstrates that with the addition of a reservoir, a peristaltic pump could be used to supply air to the sensor. The slight fluctuations in bubble generation rate at lower speeds would be averaged out over time.

To assess the sensor's ability to estimate shear stress, it is necessary to determine the relationship between bubble shedding frequency and static channel pressure using these pumps. Ideally, the shedding rate would be insensitive to static pressure. To explore this relationship, bubble shedding rate as a function of channel static pressure was evaluated. At speeds below approximately 3 m/s, a large fraction of the flow is expected to be laminar from Reynold's scaling. At flow speeds above 4 m/s, the flow becomes fully turbulent. This is consistent with the observed exponential increase in pressure fluctuations with increased flow speed. The variance in pressure at 0 m/s was 0.0000161 psi while the variance at 6 m/s was 0.0049 psi. The channel static pressure at the location of the sensor is observed to increase with the mean flow speed. The relationship appears to be quadratic at lower speeds where the flow is laminar as would be expected from Bernoulli's principle. As the flow speed increases, the rate change of pressure appears to decrease. Over a change of 0 to 6 m/s, the pressure increases by only 0.159 psi (1.10 kPa). For the syringe pump, the bubble shedding rate had an average value of about 2700 Hz over channel pressure ranging from about 15.8 to 20 psi. The bubble shedding rate for the syringe pump was essentially independent of channel static pressure: Over a change in pressure of 4.11 psi, the maximum difference between bubble shedding rate values was 187 Hz. As such, shedding rate can be safely assumed to be unaffected by pressure over the observed 0.159 psi change from 0 to 6 m/s. For the peristaltic pump, the bubble shedding rate had an average value of about 2000 Hz over channel pressure ranging from about 16 to 20.3 psi. Similarly, the bubble shedding rate for the peristaltic pump was essentially independent of channel static pressure: Over a change in pressure of 2.74 psi, the maximum difference between bubble shedding rate values was 334 Hz.

### Example 4—Signal-to-Noise Ratio Measurements

Raw central electrode pair impedance measurements were taken at mean channel flow speeds of 1, 3, and 6 m/s. The amplitude of the signal reflects the electrical impedance of the water surrounding the electrode pair, and each peak represents a bubble event. It was observed from these data that as the mean channel flow speed is increased, 1) the frequency of bubble production increases, 2) the amplitude of the impedance signal decreases, and 3) the waveform begins to resemble a sine wave more closely. Because bubble size is inversely related to shedding frequency, as the flow speed and bubble shedding rate increases, the smaller bubbles produced present less impedance change to the sensing electronics, resulting in lower signal amplitude.

At a mean flow speed of 1 m/s, a distinct shouldered rise was present in each peak (not shown). High speed footage indicated that as gas fills the needle, the impedance rises rapidly, and then once a bubble begins to form at the orifice, the rate of impedance change decreases. As the bubble detaches, it pulls with it some of the gas in the needle, and the impedance rapidly falls. This phenomenon of bubbles “scooping” gas from the needle is not observable at higher speeds (likely due to faster shedding rates) which is reflected in the impedance signal. A smoother, more sine-wave-like waveform is observed at higher flow speeds where the needle remains constantly filled with gas.

From these data, the impedance signal measured without bubble production was found to have a root mean squared (RMS) value of 0.000742 V. From this noise amplitude, the central electrode pair was calculated to have a SNR of 41.1 dB at 1 m/s, 39.0 dB at 3 m/s, and 33.7 dB at 6 m/s. The SNR is inversely related to flow speed because bubble peak magnitude decreases with speed while the noise magnitude remains constant. The SNR remains sufficiently high across all flow speeds to accurately identify peaks.

Raw far electrode pair impedance measurements were also taken at mean channel flow speeds of 1, 3, and 6 m/s. Similar trends as for the central electrode pair were observed. As the flow speed increases, the width and magnitude of the peaks decrease. In addition, the number of captured bubble events increases with flow speed. As the shedding rate increases with mean flow speed, more bubbles are produced over any given period that can be detected. The impedance measured by the probe is proportional to the volume of electric field obscured by the bubble. As the field density decays exponentially as the distance from the electrode pair increases, the impedance signal would be expected to increase exponentially as a bubble approaches the electrodes, and decay exponentially as it departs. A symmetrical waveform of this description is observed at all measured speeds.

SNR was also calculated for the far electrode signal. From the data above, the noise was found to have an RMS amplitude of 0.0014V, which is an order of magnitude greater than that of the central electrode pair. This is likely due to the geometry of the electrodes. The coaxial arrangement of the central electrode pair is ideal for maximizing sensitivity and reducing electromagnetic interference. As the central electrodes are concentric and very closely spaced, the vast majority of the current produced at the central electrode can be guaranteed to sink to the surrounding outer electrode. The far electrode pairs are formed between a point and ring with a comparatively large spacing. This arrangement is less sensitive and more susceptible to electromagnetic interference. Additionally, a small amount of noise is likely introduced by the multiplexing circuit required for angle detection. The long trace runs and additional U.LF connections within this subcircuit increase susceptibility to electromagnetic interference.

With these factors in mind, the far electrode pairs are calculated to have an average SNR of 19.6 dB at 1 m/s, 17.3 dB at 3 m/s, and 13.8 dB at 6 m/s. The SNR is sufficiently high across all flow speeds to identify peaks, but the accuracy of the bubble event detection could be enhanced through its improvement. An increased SNR would allow for the detection threshold to be lowered which would permit the detection of more bubble events and increase the quality of the regression from which flow direction is extracted. SNR may be increased by reducing the electrode-to-ring spacing, adding additional shielding to the PCB, or increasing the electrode signal amplitude.

### Example 5—Clocking Angle Measurements

Bubble detection percentages collected at each electrode angle were used to estimate flow direction. Three unique nominal sensor clocking angles were set (−44.0°, +47.5°, and)+8.0°, and three mean flow speeds were tested at each (1, 3, and 6 m/s). Five trials of 100 seconds were collected per condition. The results suggested that the instantaneous flow direction fluctuates by roughly 40° regardless of mean flow speed and clocking angle, which was consistent with previous experiments at a finer angular resolution (not shown). Direct numerical simulation (DNS) studies suggest that the standard deviation of the bubble distribution should be 11°, which aligns with the measured average standard deviation of 9±2°. Because of this distribution, three electrodes are alone responsible for determining the flow direction at any given angle and speed. Of these three electrodes, one is typically observed to detect the vast majority of the bubble events.

Across all three clocking angles tested, excluding the final 8° nominal condition which contains an outlier, the total detection percentage increases as flow speed increases. This is likely due to increased bubble shedding frequency. The outlier in the 8° clocking angle illustrates the disadvantage of fitting a univariate gaussian distribution with only three points. For the 3 m/s condition, no bubbles were detected at the 30° electrode during any of the five trials collected. Because of this, the fit was offset significantly in the direction of the “active” electrodes. This illustrates how sensitive the fit is to detection percentage at the peripheral electrodes where very few bubbles events are typically detected. Decreasing the electrode spacing would provide more regression points and greatly increase the robustness of angle detection. From these results, it appears that if a total of 16 electrodes were included in the far electrode ring, one additional electrode would be involved in each angle measurement at minimum.

These results indicate that uncertainty in bubble detection percentage increases with mean flow speed. The nominal sensor clocking angle was determined from camera images during flow operation (not shown) and compared to the angles calculated from the lines of best fit. The largest calculated error is 4.4°, and the average error across all angles is 1.9°. The average standard deviation between the measured angles across all flow speeds is 0.7°. The relative magnitude of error does not appear to be related to the flow speed. At each clocking angle, the error is biased in the same direction across all speeds. However, across all the nominal clocking angles, the direction of bias is not consistent which suggests that the error is random. The sensor offers a discrete accuracy of +10° from the electrode spacing, and an improved average accuracy of +1.0° is achieved with curve fitting. The results are summarized in Table 1 below.

TABLE 1
Bubble-based flow direction estimates as compared to flow
direction determined from long exposure photographs.

| | | Nominal clocking angle | | | | | |
|---|---|---|---|---|---|---|---|
| | | θ = −44.0° | | θ = 47.5° | | θ = 8.0° | |
| | | Measured (°) | Error (°) | Measured (°) | Error (°) | Measured (°) | Error (°) |
| flow | u = 1 m/s | −41.7 | 2.3 | 48.8 | −1.3 | 6.3 | 1.7 |
| speed | u = 3 m/s | −42.0 | 2.0 | 48.3 | −0.8 | 3.6 | 4.4 |
| | u = 6 m/s | −42.6 | 1.5 | 48.5 | −1.0 | 6.1 | 1.9 |
| | Average | | 1.91 | | −1.022 | | 2.672 |

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the apparatus, compounds, compositions, methods, and processes are described as including components, steps, or materials, it is contemplated that the apparatus, compounds, compositions, methods, and processes can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

### LIST OF FIGURE ELEMENTS

10 sensor
12 (air/gas) bubble
20 wall
22 external or liquid-contacting wall surface
30 (liquid) flow environment
100 electrode system
120 central (or interior) electrode probe
122 inner electrode conduit or tube
124 air (or gas) delivery passage or channel
126 electrical insulator sleeve
128 outer electrode conduit or tube
140 far (or exterior) electrode array
142 far electrode (or individual electrodes in a plurality of far electrodes having an angular spacing θ)
144 ground ring or electrode
146 ground isolation ring
148 electrically insulating electrode carrier
150 breakout board with a plurality of holes 152
200 sensor housing
202 housing or enclosure body
204 o-ring (or other sealing/mounting means)
206 housing or enclosure bottom or base
208 fitting or mounting means for retaining central electrode probe 120 and delivering air for bubbles
212 outer circumferential or side housing surface
214 bottom or sensing housing surface (outer, liquid-contacting surface of housing)
216 top housing surface
300 external sensor components
310 sensing electronics
320 a gas or fluid source (e.g., air delivery pump)

What is claimed is:

1. A sensor apparatus for detection of one or more liquid flow properties, the sensor comprising:
a sensor housing defining a sensing surface;
a central electrode probe positioned within the sensor housing and at the sensing surface, the central electrode probe comprising:
an inner electrode conduit exposed at the sensing surface and defining a gas delivery passage through the sensor housing to the sensing surface, and
an outer electrode conduit exposed at the sensing surface and being positioned around, spaced apart from, and electrically isolated from the inner electrode conduit; and
a far electrode array within the sensor housing and at the sensing surface, the far electrode array comprising:
a plurality of far electrodes exposed at the sensing surface, each far electrode being spaced apart from and electrically isolated from other far electrodes and the central electrode probe, and
a ground electrode exposed at the sensing surface being spaced apart from and electrically isolated from the plurality of far electrodes and the central electrode probe.

2. The sensor of claim 1, wherein the inner electrode conduit and the outer electrode conduit are coaxially aligned.

3. The sensor of claim 1, wherein:
the inner electrode conduit comprises a cylindrical inner electrode tube;
the outer electrode conduit comprises a cylindrical outer electrode tube;
the plurality of far electrodes comprises a plurality of far electrode wires; and
the ground electrode comprises ground electrode ring encircling the plurality of far electrode wires.

4. The sensor of claim 3, wherein:
the inner electrode tube has a diameter in a range of 0.01 mm to 0.2 mm;
the outer electrode tube has a diameter in a range of 0.3 mm to 3 mm;
each far electrode wire has a diameter in a range of 0.02 mm to 0.4 mm;
the ground electrode ring has an inner diameter in a range of 2 mm to 20 mm and an outer diameter in a range of 3 mm to 30 mm.

5. The sensor of claim 1, wherein:
the inner electrode conduit comprises stainless steel;
the outer electrode conduit comprises stainless steel;
the plurality of far electrodes comprises stainless steel; and
the ground electrode comprises brass.

6. The sensor of claim 1, wherein each far electrode is spaced apart from the central electrode probe by a distance in a range of 0.5 mm to 10 mm.

7. The sensor of claim 1, wherein each far electrode is spaced apart from its adjacent far electrode or far electrodes by an angle in a range of a 2° to 40°.

8. The sensor of claim 1, wherein the plurality of far electrodes is arranged in a circular arc relative to and concentric with the central electrode probe, the circular arc spanning at least 10°.

9. The sensor of claim 1, wherein the plurality of far electrodes has 2 to 200 far electrodes.

10. The sensor of claim 1, further comprising:
an electrically insulating electrode carrier at the sensing surface, the electrode carrier being adapted to (i) retain the central electrode probe and the plurality of far electrodes in a selected spatial relationship between each other, and (ii) maintain electrical isolation between the central electrode probe, the plurality of far electrodes, and the ground electrode.

11. The sensor of claim 1, wherein the sensing surface is a flat surface.

12. The sensor of claim 1, wherein the sensing surface is a curved surface.

13. The sensor of claim 1, further comprising:
a gas source in fluid communication with the gas delivery passage, the gas source being adapted to deliver gas at a controlled volumetric flow rate through the gas delivery passage and into an external liquid flow environment for gas bubble generation during use of the sensor.

14. The sensor of claim 13, wherein the gas delivered by the gas source comprises air.

15. The sensor of claim 1, further comprising:
sensing electronics in electrical communication with the central electrode probe and the far electrode array, the sensing electronics being adapted to apply a voltage and sense a resulting impedance (i) between the inner electrode conduit and the outer electrode conduit, and (ii) between an individual far electrode and the ground electrode.

16. The sensor of claim 1, wherein the sensor is mounted in a wall having an external surface such that the sensing surface of the sensor is flush with the external surface of the wall.

17. An aquatic vessel comprising:
a hull; and
a sensor according to claim 1 mounted (i) within the hull and with the sensing surface being outwardly facing, and (ii) at a water-contacting position on the hull during operation of the aquatic vessel.

18. A method for detecting one or more liquid flow properties, the method comprising:
providing a sensor according to claim 1 with the sensing surface of the sensor in contact with a liquid flow environment in which liquid is flowing over the sensing surface;
delivering a gas through the gas delivery passage a volumetric flow rate sufficient to generate gas bubbles in the liquid flowing over the sensing surface;
detecting the generated gas bubbles in the liquid flowing over the sensing surface with at least one of the central electrode probe and the far electrode array; and
determining one or more liquid flow properties in the liquid flowing over the sensing surface from the detected gas bubbles, the liquid flow properties being selected from the group consisting of wall shear stress, flow direction, flow speed, and combinations thereof.

19. The method of claim 18, comprising determining the wall shear stress.

20. The method of claim 18, comprising determining the flow speed.

21. The method of claim 18, comprising determining one or both of the flow direction and the flow speed.

22. The method of claim 18, wherein:
the volumetric flow rate of the gas is in a range of 0.01 ml/hr to 10 ml/hr; and
the liquid flowing over the sensing surface has a mean flow speed in a range of 0.1 m/s to 20 m/s.

23. The method of claim 18, wherein the liquid flow environment comprises water.
